(19) United States
(12) Patent Application Publication
(10) Pub. No.: US 2022/0343693 A1
(43) Pub. Date: Oct. 27, 2022

(54) FINE GENERATION METHOD AND SYSTEM FOR AUTOMATIC GENERATION OF FINES

(71) Applicant: Roads and Transport Authority, Dubai (AE)

(72) Inventors: Tariq ISMAIL, Dubai (AE); Omer SYED, Dubai (AE); Faheem GILL, Dubai (AE); Shehla RAFIQ, Dubai (AE); Khaled ABDULRAHMAN AL AWADHI, Dubai (AE)

(21) Appl. No.: 17/639,885

(22) PCT Filed: Aug. 30, 2020
(86) PCT No.: PCT/IB2020/058083

§ 371 Date: Mar. 2, 2022

(30) Foreign Application Priority Data
Sep. 2, 2019 (GB) 1912560.8

(51) Int. Cl. G07B 15/00; G06Q 50/30

(52) U.S. Cl. CPC G07B 15/00; G06Q 50/30

(57) ABSTRACT

A fine generation method for automatic generation of fines related to a transport network associated with a transportation network company. The method comprises receiving, by a regulatory monitoring system, real time vehicle data related to a vehicle within the transport network. The method further comprises receiving, from a transportation network company, trip data relating to one or more trips of the vehicle, and storing the trip data in a database. The method also comprises generating violation data by analysing the real time vehicle data and the trip data stored in the database to detect if a violation has occurred, and generating a fine based on the violation data.

### FIELD

The present disclosure relates to a fine generation method and system for automatic generation of fines related to a transport network associated with a transportation network company.

### BACKGROUND

Recently, so-called e-hailing apps (also sometimes referred to as ride sharing, ride hailing applications, or transportation network carriers) such as Uber and Careem have become increasingly popular for allowing users to book, hail, and pay for rides in vehicles such as taxis, limousines, and more recently scooters or other vehicles. For example, a user may use an e-hailing application on their portable device, such as a smartphone, to order a taxi to pick them up at their location. The taxi may then take the user on a trip to the user's desired drop off point, and payment for the trip may be automatically carried out via the application.

Furthermore, a Transport Network Company (TNC) may operate a fleet of vehicles such as taxis and limousines for use by a user. In some jurisdictions, the vehicles may be privately owned and operated by individuals operating the rider hailing app. In other jurisdictions, the vehicles may be owned and/or operated by a TNC under licence from an appropriate licensing authority such as a local municipality or licensing office. In such circumstances, the terms of operation and associated fares may be agreed between the TNC and licensing authority (e.g. municipality). In other words, operation of vehicles that may be used by a ride hailing application may be subject to regulation by the appropriate authority.

For example, a TNC may operate a database which stores trip data such as pickup time, drop-off time, pickup location, and drop-off location for a trip or trips of vehicles that they operate. For example, the TNC may share the cost of a trip between the passenger and the TNC.

As part of a regulatory framework, the TNC may report trip data to the licensing authority (such as a local municipality) to help provide an overview of the TNC's footprint in the municipality. However, such data may be open to errors or manipulation, which may lead to revenue loss to the municipality, for example, if the regulatory framework provides for a predetermined percentage of a fare to be paid to the municipality as part of the licensing fee that allows the TNC to operate in the municipality.

Furthermore, as the number of vehicles goes up, the likelihood that errors in the fare amount charged or discrepancies between an expected (estimated) fare and a fare reported by the TNC may increase. Accordingly, the revenue to the licensing authority may be incorrect. This may also lead to issues for the TNC when trying to comply with the regulatory framework already agreed with the licensing authority (e.g. municipality).

Examples of the present disclosure seek to address or at least alleviate the above problems.

### SUMMARY

In a first aspect, there is provided a fine generation method for automatic generation of fines related to a transport network associated with a transportation network company, the method comprising: receiving, by a regulatory monitoring system, real time vehicle data related to a vehicle within the transport network; receiving, from a transportation network company, trip data relating to one or more trips of the vehicle; storing the trip data in a database; generating violation data by analysing the real time vehicle data and the trip data stored in the database to detect if a violation has occurred; and generating a fine based on the violation data.

In a second aspect, there is provided, a fine generation system for automatic generation of fines related to a transport network associated with a transportation network company, the fine generation system comprising: a regulatory monitoring system operable to receive real time vehicle data related to a vehicle within the transport network; a database operable to receive, from the transportation network company, trip data relating to trips of the vehicle, and to store the trip data; and a violation module operable to generate violation data by analysing the real time vehicle data and the trip data stored in the database to detect if a violation has occurred, and to generate a fine based on the violation data.

Other aspects and features are defined in the appended claims.

For example, by comparing the real time vehicle data with the trip data, a regulatory authority may be able to determine if a violation has occurred. For example, an estimated fare may be generated from the real time vehicle data and compared with a reported fare generated from the trip data. If the estimated fare does not agree with the fare reported by the TNC for example in accordance with an agreement provided within the regulatory framework, then a fine may be generated. Therefore, a likelihood that the licensing authority may miss out on revenue may be reduced. Furthermore, compliance of the TNC with the regulatory framework may be more accurately monitored and ensured, because the real-time trip data relating to the vehicle may be used to determine if a violation has occurred and a fine generated automatically.

### DRAWINGS

Examples of the disclosure will now be described by way of example only with reference to the accompanying drawings, in which like references refer to like parts, and in which:

FIG. 1 is a schematic diagram of a fine generation system;

FIG. 2 is a schematic diagram of a data transfer process;

FIG. 3 is a flow chart of a method for automatic generation of fines;

FIG. 4 is a flow chart of further details of the method of FIG. 3;

FIG. 5 is schematic diagram of apparatus for detecting trips of a vehicle;

FIG. 6 is a flow chart of a method for detecting trips of a vehicle;

FIG. 7 is a flow chart of a method for detecting if a trip is active; and

FIG. 8 is a schematic diagram of a computer system.

### DETAILED DESCRIPTION

A fine generation method and system for automatic generation of fines is disclosed. In the following description, a number of specific details are presented in order to provide a thorough understanding of the examples of the disclosure. It will be apparent however to a person skilled in the art that these specific details need not be employed in order to practise the examples of the disclosure. Conversely, specific details known to the person skilled in the art are omitted for the purposes of clarity in presenting the examples.

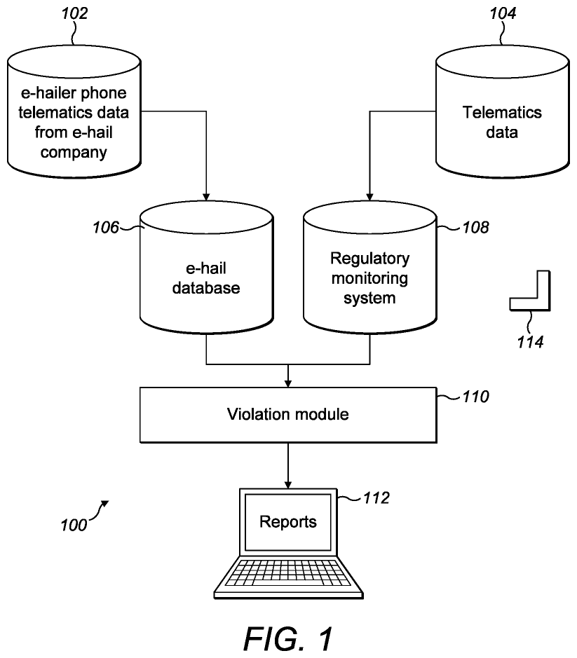

FIG. 1 is a schematic diagram of a fine generation system 100. The fine generation system may automatically generate fines related to a transport network associated with a transportation network company. In examples, the fine generation system 100 comprises an e-hail data source 102, a vehicle telematics data source 104, an e-hail database 106, and regulatory monitoring system 108, a violation module 110, and a user interface device 112.

In examples, the fine generation system 100 comprises a seat sensor 114 associated with a seat located in a vehicle. The seat sensor may generate seat data indicative of whether a vehicle occupant is occupying the seat. The seat data may be included as part of the data provided by the vehicle telematics data source 104. However, in other examples, the seat sensor may be omitted. The use of seat data will be described in more detail later.

In examples, the e-hail data source 102 may provide trip data such as e-hail telematics data generated by an e-hail provider (also referred to herein as a transportation network company) to the e-hail database 106. For example, a user may use an e-hailing app on a portable device such as a smart phone to book a taxi ride. During the taxi ride, the e-hailing app may measure attributes of the vehicle's position such as location, speed, and direction based on positioning sensors of the mobile device (e.g. global positioning system (GPS) sensors), and generate e-hail telematics data from the measured attributes. In examples, the e-hailing app may generate e-hail fare data relating to a fare to be charged to the user. In examples, the e-hail data source 102 may provide the e-hail fare data to the e-hail database 106 for storage by the e-hail database 106.

More generally, a transportation network company may provide an e-hailing app for use on a user's mobile device. The e-hailing app may generate trip data relating to one or more trips of a vehicle or vehicles. The trip data may include the e-hail telematics data and/or the e-hail fare data. In other words, in examples, the e-hail database 106 is operable to receive, from the transportation network company, trip data relating to trips of the vehicle, and to store the trip data.

In examples, the regulatory monitoring system 108 is operable to receive real time vehicle data related to a vehicle within the transport network. For example, the regulatory monitoring system 108 may receive vehicle data from the vehicle telematics data source 104.

In examples, the violation module 110 is operable to generate violation data by analysing the real time vehicle data and the trip data stored in the database to detect if a violation has occurred, and to generate a fine based on the violation data.

Therefore, for example, the violation data may be used to monitor is a transportation network company is complying with a regulatory framework, and be fined according if violations occur. The operation of the fine generation system 100 will be described in more detail later below.

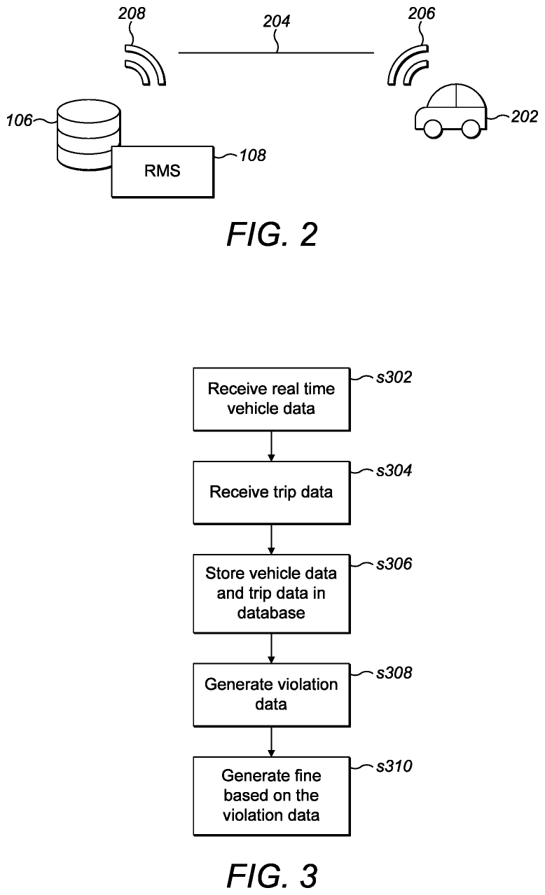

FIG. 2 is a schematic diagram of a data transfer process according to examples of the disclosure. In the example shown in FIG. 2, a vehicle 202 associated with the transportation network company (TNC) may communicate wirelessly with the regulatory monitoring system (RMS) 108 for example via a mobile telecommunications network 204. However, it will be appreciated that other methods of communication may be used. In examples, a mobile device of a user, such as a passenger in the vehicle 202, may communicate via the telecommunications network 204 with the regulatory monitoring database 108. In other words, for example, the vehicle 202 may act as the telematics data source 104 to provide the real-time vehicle data, and the transportation network carrier driver's device may act as the e-hail data source 102. For example, referring to FIG. 2, the vehicle 202 may send data via the network 204 by using a private gateway 208. The ehail database 106 and/or the RMS may communicate with the vehicle over the network 204 using a security layer 206.

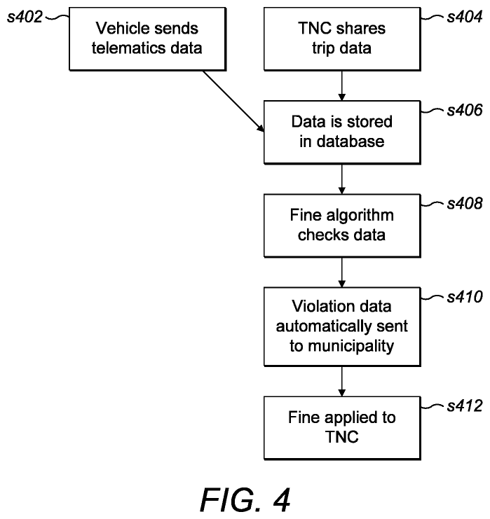

An example of operation of the fine generation system 100 will now be described in more detail with reference to FIGS. 3 and 4.

Referring to FIG. 3, at a step s302, the regulatory monitoring system 108 receives real time vehicle data related to a vehicle, such as the vehicle 202, within the transport network. For example, referring to FIG. 4, the vehicle 202 may send, at a step s402, telematics data to the RMS 108. In examples, the step s302 may include the step s402 so that the RMS 108 can receive the vehicle data from the vehicle. In other words, in examples, the vehicle data comprises telematics data indicative of one or more attributes of position of the vehicle. For example, the telematics data may comprise one or more of: vehicle location; vehicle speed; vehicle direction; and vehicle acceleration, although it will be appreciated that other data could be included. Returning to FIG. 3, at a step s304, trip data relating to one or more trips of the vehicle is received from the TNC. For example, referring to FIG. 4, the TNC may share, at a step s 404, trip data such as that relating to one or more trips of the vehicle 202.

At a step, s306, the trip data is stored in a database. In some examples, the RMS 108 comprises an RMS database operable to store the vehicle data. In these examples, the vehicle data sent by the vehicle 202 (for example at the step 402), and the trip data shared by the TNC at the step s404 are stored, at a step s406 in an associated database. For example, the trip data may be stored in the e-hail database 106 and the vehicle data may be stored in the RMS database. However, it will be appreciated that other databases could be used, and the trip data and vehicle data could be stored in the same or different databases. In examples, the RMS database and/or the ehail database may be a NoSQL database for receiving real-time streamed data from the TNC and/or vehicle(s). For example, data sent by the TNC may be provided in a CSV (comma separated value) format, or JavaScript Object Notation (JSON) format, or MQTT

(Message Queuing Telemetry Transport) format, although it will be appreciated that other suitable formats could be used.

At a step s308, violation data is generated by analysing the real time vehicle data and the trip data stored in the database to detect if a violation has occurred. For example, this may be implemented by a Fine Algorithm implemented by the violation module 110 at a step s408.

At a step s310, a fine may be generated based on the violation data. For example, the violation data may automatically be sent, at a step s410, to a server or other system provided by a municipality, for example for output by the user interface device 112. If a violation is determined to have occurred, then a fine may be applied, at a step s412, to the TNC. For examples, the steps s410 and s412 may be implemented as part of the step s310.

For example, the vehicle data may comprise one or more of: position (e.g. latitude/longitude); trip start time; trip end time; passenger on/off (i.e. whether there is a passenger in the vehicle). The vehicle data may be streamed to the RMS database in real time and cached into a messaging queue. For example, the messaging queue may be a streaming service to send the vehicle data from one or more vehicles into a cached server (for example implemented by the RMS) where the data may be stored and sorted, then sent to cloud based virtual machines. The virtual machines may then send the cached vehicle data to the violation module 110. In examples, the violation module 110 may act as a Fine Automation Engine (FAE).

Although the steps s302 to s310 in FIG. 3, and the steps s402 to s412 in FIG. 4 have been described sequentially, this should not be taken as implying that the steps of FIGS. 3 and 4 have to be carried out in the order described. For example, the order of the steps s302 and s304 could be reversed or these steps could be carried out at the same time as each other.

In examples, the violation module 110 is operable to implement one or more rules to determine if a violation has occurred. As mentioned above, the real-time vehicle data and the trip data provided by the TNC may be analysed by the violation module 110. For example, the violation module 110 may generate estimated fare data. The estimated fare data may relate to a trip taken by the vehicle, such as the vehicle 202. In examples, the estimated fare data is generated from the real time vehicle data.

In examples, the violation engine may implement pre-built rules based on a tariff allowed for the vehicle, for example based on trip parameters such as time of day, day of the week, location of pickup, location of drop off, and type of vehicle, although it will be appreciated that other parameters may be used. The violation engine may set fare dependency aspects, such as fare per distance (e.g. AED/km), waiting time (e.g. AED/minute), and location (for example based on geofencing—if the vehicle is within a geofenced area, then a premium may be charged), although it will be appreciated that other fare dependency aspects may be used. In examples, the fare dependency aspects may be based on the trip parameters. Here, the currency AED refers to United Arab Emirates Dirham, although it will be appreciated that any other currency could be used.

In examples, the violation engine 110 may determine that a violation has occurred based on one or more violation parameters such as one or more of location start and end time, trip start time and trip end time, trip duration, trip time, waiting time, driver behaviour score, and vehicle type, although it will be appreciated that other violation parameters could be used.

In an example, the estimated fare data comprises an estimated fare based on one or more estimated parameters. In an example, estimated parameters may be calculated according to equation 1:

EstimatedAmount=(Estimated_Booking_Fee+Estimated_Start_Fare+Estimated_Distance_Charge+Estimated_Time_Charge+Estimated_Toll_Charge+Estimated_Waiting_Charge+Estimated_City Change_Charge+Estimated_Special event_Charge+Estimated_Extra_Charge−Estimated_Discount+Drone_Delivery_Charge+Altitude_Counter+Drone_Vector_Charge+Scooter_Charge+Scooter_Counter)*Multiplier_factor Equation 1:

However, it will be appreciated that one or more of the parameters of equation 1 may be omitted or modified as appropriate.

Referring to equation 1, the estimated parameters may be defined as follows:

Estimated_Booking_Fee—fee may be calculated as per a matrix (e.g. look up table) based on Transportation Type and Period. Transportation Type may be a vehicle type such as Taxi, Limousine, Bus, Scooter, or Drone, although it will be appreciated that other vehicle type could be used.

Estimated_Start_Fare—fee may be calculated based on one or more of Transportation Type, Location, and detected time period. The location may be based on location coordinates received from the vehicle telematics data such as GPS data provided by the vehicle. The detected time period (e.g. time of the day/Day) may be based on trip start time. In some examples, the estimated start fee is based on a Special Event Location, for example if pick up occurs at a location where a special event is occurring such as a horse race or motor race. In examples, the estimated start fee may be based on the geofencing for example defined by the municipality. For example, an extra charge (e.g. a fixed flagfall) may added for trips starting from certain locations such as an airport and/or port. In examples, the Estimated_Start_Fare may include a booking fee, for example for pre-booking transportation on the vehicle (e.g. scheduling pickup) in advance of the trip.

Estimated_Distance_Charge—fee may be calculated based on one or more of Vehicle Type, Location, Period (trip time), and Special Event Location.

Estimated_Time_Charge—fee may be calculated based on the duration of the trip, for example as indicated by the vehicle telematics data. In examples, this fee may be based on whether the trip occurs within a particular time period of the day, for example during rush hour, or at night (e.g. as defined between a start and end time such as 07:00-10:00 and 17:00-19:00 for rush hour, or between 23:00-06:00 for night time).

Estimated_Toll_Charge—fee may be included, for example when the vehicle is detected to pass through one or more toll gates based on vehicle location coordinates. In examples, the Estimated_Toll_Charge may be based on toll gate data provided by the vehicle. For example, each time the vehicle passes through a toll gate where a charge is incurred, that charge may be included in the estimated amount.

Estimated_Waiting_Charge—fee may be calculated based on the mean average speed of the vehicle, for example as determined over a predetermined time period such as every 1 s, 5 s, 10 s, 15 s, 20 s, 60 s, although it will be appreciated that other suitable time periods could be used. For example, if the mean average speed during the predetermined time period is less than a low speed threshold, then a low speed time charge may be accumulated. In an example, the rate for where the mean average speed is less than the low speed threshold is distributed based on 25AED/hr. However, it will be appreciated that other suitable rates could be used.

Estimated_CityChange_Charge—fee may be applied when a border crossing or change of city is detected based on location data of the vehicle. For example, if it is detected that there is a change in city and/or a destination is one or more of a predetermined destination, such one of the Northern Emirates of the United Arab Emirates or Sharjah.

Estimated_Extra_Charge—fee may be based on a driver behavior score. For example, the driver behavior score may be based on detection of events such as over speeding (exceeding a speed limit), harsh braking (deceleration greater than a harsh braking threshold), and harsh acceleration (acceleration greater than a harsh acceleration threshold) although it will be appreciated that a driver behaviour score could be generated in other suitable manners.

Estimated_Discount—a fee reduction may apply, for example based on the status of the passenger (e.g. membership level), or special offers or promotional discounts, although it will be appreciated that other discounts may be applied.

Drone_Delivery_Charge—for example this fee may apply if the vehicle is a drone or other aerial vehicle. A fee may be charged relating to the cost of delivering/transporting/moving the drone to the pickup location from the drone's previous location.

Altitude_Counter—for example this fee may apply if the vehicle is a drone or other aerial vehicle. The fee may be based on the maximum altitude that the drone achieves during the trip. Alternatively, the fee may be based on the total change in altitude during the trip.

Drone_Vector_Charge—for example this fee may apply if the vehicle is a drone or other aerial vehicle. The Drone vector charge may be a charge based on the vector route (e.g. 3-dimensional route) that is taken by the drone. For example, some routes may be premium routes and have a toll charge (e.g. aerial toll) associated with them.

Scooter_Charge—for example this fee may apply if the vehicle is a scooter. For example, a fixed fee may be added if the vehicle is a scooter.

Scooter_Counter_Charge—fee may apply if the vehicle is a scooter. For example, this fee may be included based on the number of scooters available.

Multiplier_Factor—for example, a multiplier factor of 1.0, 1.1, 1.2, 1.3, 1.4, 1.5 or other value may be applied. The multiplier factor may be zero or negative.

In equation 1, the estimated fare may be considered to be calculated according to the mentioned parameters, but omitting the multiplier factor.

More generally, in examples, the vehicle data comprises one or more of: toll gate data; vehicle type data; engine parameter data; passenger count data; and driver identification data. In examples, more generally, the estimated amount (and/or estimated fare) may be based on the vehicle data.

In examples, the trip duration may be based on the trip start and end time. In examples, the vehicle data comprises seat data generated using a seat sensor associated with a seat located in the vehicle (such as seat sensor 114), the seat data being indicative of whether a vehicle occupant is occupying the seat. For example, the start and end time may be measured based on seat sensor data (e.g. comprising data relating to seat sensor events) received from the seat sensor 114. In examples, the start and end time may be based on seat sensor events received within a +/−2 minute time span of the start time as indicated by start time data received from the e-hailer app. In examples, location may be determined based on the passenger on/off events from seat sensor, where passenger on/off is taken to mean whether a person is occupying the seat, for example. Trip detection using a seat sensor will be described in more detail later below.

As mentioned above, violation data may be generated by analysing the real time vehicle data and the trip data stored in the database to detect if a violation has occurred. In examples, the trip data comprises reported fare data for a trip that is reported by the transportation network company, for example from an e-hailing app of a user's portable device. For example, the reported fare data may comprise a reported fare for a trip as indicated by the reported fare data provided by the TNC. In examples, generating the violation data comprises comparing a reported fare as indicated by the reported fare data with an estimated fare as indicated by the estimated fare data. In examples, generating the fine comprises generating the fine if a predetermined condition with respect to the reported fare and the estimated fare is satisfied. In examples, the predetermined condition is that the estimated fare is a threshold amount different from the reported fare. For example, the reported fare may be compared with the estimated amount, and if the difference between them is greater than a fare violation threshold, then a fine may be generated.

Some examples of instances where a fine might be generated are given below.

ID: Trip A

Fare Charged by ehailer=135 AED

Assumptions:

Vehicle Type=5-seater Limousine

Timeperiod of Trip Start=Peak Hour of Night (e.g. 19:00-22:00)

Start Location=Dubai Mall, Dubai

End Location=Dubai Airport, DXB, Dubai

Toll gate passes detected: 2

Distance Travelled: 50 km

Duration: 80 minutes

Wait Time detected: 10 minutes

Calculation:

Estimated Booking Fee: 6 AED

Estimated Start Fee: 4 AED

Time Charge: 5 AED

Distance Charge: 90 AED

Tolls: 10 AED

City Change Charge: 30 AED

Extras: 0 AED

Estimated Fare=145 AED

### Violation Rule:

Violation=Yes based on ruling that Estimated Fare*1.3>Fare Charged by ehailer

ID: Trip B

Fare Charged by ehailer=AED 1400

Assumptions:

Vehicle Type=2-seater drone

Time period of Trip Start=Rush Hour (e.g. 07:00-10:00)

Start Location=Dubai Mall, Dubai

End Location=Dubai Godolphin Stables, Dubai

Toll gate passes detected: 2

Distance Travelled: 80 km

Duration: 90 minutes

Wait Time detected: 5 minutes

Calculation:

Estimated Booking Fee: 30 AED

Estimated Start Fee: 95 AED

Time Charge: 30 AED

Distance Charge: 900 AED

3D Tolls: 150 AED

City Change Charge 0 AED

drone_delivery_charge: 40 AED

Extras: 0 AED

Estimated Fare=1245 AED

### Violation Rule:

Violation=Yes based on ruling that Estimated Fare*1.3>Fare Charged by ehailer In the examples of Trip A and Trip B, the estimated fare is calculated using equation 1 but omitting the multiplier factor. In these examples, the multiplier factor is 1.3. In other words, for example, a violation is determined to have occurred if the estimated amount is greater than the reported fare. For example, the predetermined condition indicating that a violation has occurred and a fine should be generated may be that the estimated fare multiplied by a multiplier factor is greater than the reported fare. However, it will be appreciated that violations may be determined to have occurred based on other factors. For example, whether a violation is considered to have occurred may be based on one or more of: location start and location end position; trip start time and trip end time; trip duration; trip time (time of day that a trip occurred); waiting time, driver behaviour score; and vehicle type.

In other examples, one or more of the following may be used to determine if a violation has occurred:
1. Trip Start time=f (tariff start fare based on 1. Trip day, 2. Trip vehicle type)
2. Trip start Location=f (tariff start fare based on if the location is a high traffic location such as an airport)
3. Trip Time=f (time the trip has lasted and charges a time fare)
4. Trip Distance=f (distance of the trip and charges a fare based on distance)
5. Waiting Time=f (if the car is not moving it will charge a subcharge)
6. Driver Behaviour Score=f (how well the driver drove, and can adjust the rate based on this)
7. Vehicle type=f (number of seats may be used to set the rate for items 1-4)
   In the enumerated list above the terminology f( . . . ) for example indicates a function of the parameters mentioned within the parentheses.

In examples, fares may be reported from a plurality of vehicles and from a plurality of devices running an e-hailing app, for example. In other words, for example, the techniques described herein are applicable to more than one vehicle and to many different types of vehicle.

For example, the user interface device 112 may be configured to provide output indicative of the violations of vehicles associated with the TNC, for example those operated by the TNC. The user interface device 112 may be configured to provide a filtering function to allow an operator of the user interface device 112 to view a plurality of different violations, for example filtered according to desired requirements. For example, a municipality may provide a regulatory framework within which TNCs must operate. The municipality may operate the user interface device 112 so as to view violations of the terms of regulatory framework, for example, as indicated by fare differences between fares reported by the TNC and estimated fares from the vehicles generated from the real-time vehicle data. The municipality may then follow up with the TNC to help ensure that the TNC is complying with the regulatory framework.

In examples, the violation module 110 is operable to predict the number of violations that may occur on a particular day, or during a particular time period, for example based on previous violation history, for example relating to the same or similar time or day in the past. For example, the violation module 110 may predict that a certain number of violations may occur during evening rush hour on the last day of the week based on previously recorded violations for that time period.

In some examples, the techniques described herein may be applied to more than one TNC, for example, so that the municipality may monitor all the TNCs operating within a particular area, such as within a city, Emirate, or within a country. Therefore, for example, the municipality may use the techniques described herein to monitor and grade each TNC in real time, for example based on the real time vehicle data. Therefore, for example, this may help improve safety as well as helping to improve revenue monitoring and accounting. Furthermore, for example, by automatically generating a fine based on violation data, TNCs may automatically be encouraged to comply more rigorously with the regulatory framework without incurring additional costs and administrative burden for the municipality. Therefore, a more efficient system and method for automatic generation of fines related to a transport network associated with a transportation network company may be provided.

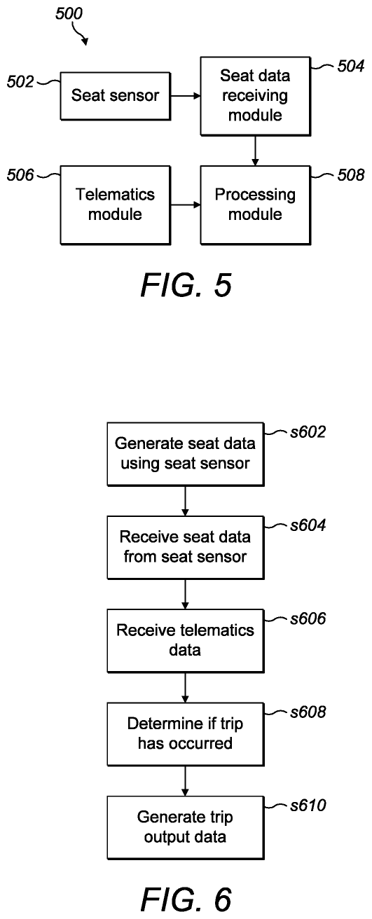

As mentioned above, in some examples seat data from a seat sensor may be used to determine is a trip has occurred. This functionality will now be described in more detail with reference to FIGS. 5 to 7.

FIG. 5 is schematic diagram of apparatus 500 for detecting trips of a vehicle, such as the vehicle 202, according to examples of the disclosure. The apparatus 500 comprises a seat sensor 502, a seat data receiving module 504, a telematics module, and a processing module 508. In examples, the vehicle 202 may comprise the apparatus 500.

In examples, the seat sensor 502 is associated with a seat located in the vehicle, and the seat sensor 502 is operable to generate seat data indicative of whether a vehicle occupant is occupying the seat. In examples, the seat sensor 502 is the same as the seat sensor 114 mentioned above with respect to FIG. 1, although in other examples it may be different. In examples, the seat sensor 502 comprises a pressure sensitive sensor located beneath the seat for generating the seat data. For example, the seat sensor 502 may generate seat data indicating that the vehicle occupant is occupying the seat if a detected weight as indicated by the seat sensor 502 is greater than a threshold weight.

In an example, the seat sensor 502 is a substantially square, planar sensor of around 38 cm by 38 cm which is operable to detect pressure and/or weight of an object on the seat. In examples, the seat sensor 502 may be positioned with respect to the seat so as to be coupled to a seat surface on which the user may sit. For example, if the seat sensor 502 detects that an object (e.g. a user) on the seat weights greater than a threshold weight of 15 kilograms, then the seat is determined as being occupied and the seat data generated accordingly. However, it will be appreciated that other configurations and threshold weights are possible.

In other examples, the seat sensor 502 may comprise a video camera and associating processing elements operable to determine if the seat is occupied based on image analysis of images captured by the video camera. In some examples, the seat sensor 502 may comprise a light sensitive element located within the seat such that occlusion of the light sensitive element causes a change in output signal of the seat sensor 502. The seat may be determined to be occupied based upon a change in the output signal for example.

In examples, the seat sensor 502 is operable to generate a binary output indicative of whether or not the seat is occupied. For example, “seat occupied”=1, and “seat not occupied”=0, although the binary values could be assigned differently. However, it will be appreciated that other suitable seat sensors for determining if a seat is occupied could be provided.

Although one seat sensor is described with respect to FIG. 5, it will be appreciated that one or more seat sensors may be provided. For example, each seat may be provided with a respective seat sensor with similar or the same functionality as the seat sensor 502. However, the seat sensors could be different from each other. Furthermore, not every seat may be provided with a seat sensor. For example, a seat sensor may be omitted in respect of a driver's seat.

In examples, the seat sensor 502 is operable to send seat data to the seat data receiving module 504. In an example, the seat data receiving module 504 may be implemented by the regulatory monitoring system 108. However, in other examples, the seat data receiving module 504 may be implemented by suitable circuitry within the vehicle, for example. In some examples, the seat data receiving module 504 may be implemented by a virtual machine running on a cloud server connected via a network to the seat sensor 502. In other words, the seat data receiving module 504 is operable to receive the seat data from the seat sensor 502.

In examples, the telematics module 506 is operable to receive telematics data indicative of one or more attributes of motion of the vehicle, such as the vehicle 202. In some examples, the telematics module may act as the telematics data source 104 described above with respect to FIG. 1. For example, attributes of motion of the vehicle may relate to one or more of; vehicle position; vehicle speed; and vehicle acceleration, although it will be appreciated that other attributes could be used. Furthermore, it will be appreciated that the telematics data may comprise other data such as that described above with respect to the telematics data source mentioned for FIG. 1. In examples, the telematics module 506 may send the telematics data to the processing module 508.

The processing module may receive the telematics data from the telematics module 506 and the seat data sent by the seat data receiving module 504. The processing module 508 is operable to determine if a trip has occurred based on the seat data and the telematics data. The processing module is operable to generate trip output data indicative of attributes of the trip if a trip is determined to have occurred. Therefore, for example, detection of a trip may be performed automatically.

In examples, the processing module 508 may be implemented by the regulatory monitoring system 108, although it will be appreciated that the processing module 508 could be implemented in other suitable ways. For example, the processing module 508 may be implemented by a processor within the vehicle, and the trip output data sent from the vehicle via a suitable network to the regulatory monitoring system 108. In other examples, the trip output data may be sent to the TNC, for example, so that a fare may automatically be generated by the TNC e.g. via an e-hailing application.

FIG. 6 is a flow chart of a method for detecting trips of a vehicle according to examples of the disclosure. At a step s602, seat data indicative of whether a vehicle occupant is occupying the seat is generated using a seat sensor (such as the seat sensor 502) associated with a seat located in the vehicle (such as the vehicle 202). At a step s604, the seat data is received form the seat sensor, for example by the seat data receiving module 504. At a step s606, telematics data indicative of one or more attributes of motion of the vehicle is received, for example received from the telematics module 506 by the processing module 508. At a step s 608, it is determined if a trip has occurred based on the seat data and the telematics data. For example, the processing module 508 may determine if a trip has occurred, as mentioned above. At a step s610 trip output data is generated, the trip output data being indicative of attributes of the trip if a trip is determined to have occurred. As mentioned above, in examples, the processing module 508 may generate the trip output data, although it will be appreciated that the trip output data could be generated by other methods. Although the steps s602 to s610 have been described sequentially, this should not be taken as implying that the steps of FIG. 6 have to be carried out in the order described. For example, the order of carrying out the steps s604 and s606 could be reversed or these steps could be carried out at the same time as each other.

In examples, the trip output data may comprise attributes of the trip such as one or more of the parameters used for calculating the estimated amount, for example as described above with reference to equation 1. However, it will be appreciated that the trip output data could comprise other suitable data related to a trip that is detected using the seat sensor 502, or the seat sensor 114, for example.

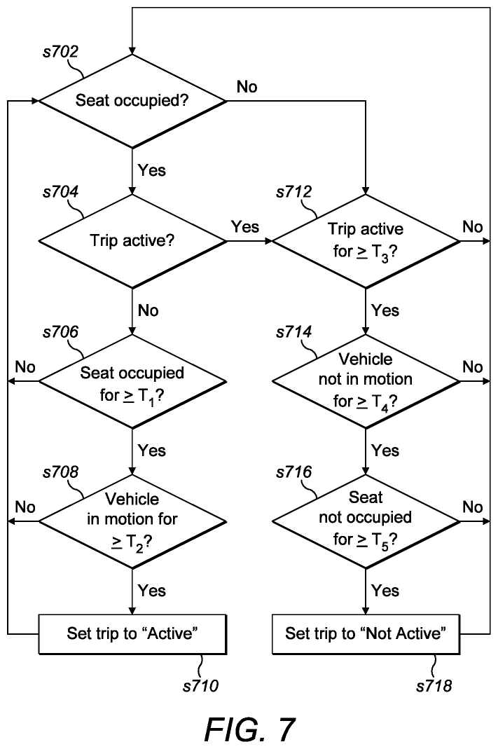

The techniques described herein may allow a trip to be automatically detected and trip output data generated accordingly, for example based on the seat sensor data and telematics data of the vehicle. However, it will be appreciated that, once a passenger enters the vehicle, they may not stay seated on the same seat throughout the duration of the trip. In order to help address this problem, one or more thresholds may be implemented with respect to whether the seat is occupied and whether the vehicle is in motion, for example. This functionality will now be described with reference to FIG. 7.

FIG. 7 is a flow chart of a method for detecting if a trip is active according to examples of the disclosure.

In examples, a trip may be considered to have started when the seat data changes from false (0) indicating that the seat is not occupied, to True (1) indicating that a seat is occupied. For example, a time stamp of a seat data change from False to True may be temporarily stored in a memory of the seat data receiving module 504.

Referring to FIG. 7, at a step s702, the seat sensor 502 detects if the seat is occupied or not. The seat data generated by the seat sensor 502 may be sent to the processing module 508, for example via the seat data receiving module 504. In examples, the seat sensor 502 is operable to continuously the seat data to the processing module 508, for example so that the processing module 508 can monitor if the seat is occupied or not.

If the seat is occupied, as indicated by the seat data, then, at a step s704, the processing module 508 determines if the trip is active. If the trip is not considered to be active, then processing passes to a step s706.

At the step s706, the processing module 508 determines if the seat if occupied for a time greater than or equal to a first threshold time T₁. In an example, the first threshold time T₁ is 60 seconds, although other values such as 0 s, 10 s, 20 s, 30 s, 40 s, 50 s or any other length of time could be used. If the seat is occupied for a time less than the first threshold time T₁, then processing proceeds to the step s702. If the seat is occupied of a time than or equal to the first threshold time T₁, then processing proceeds to a step s708.

At the step s708, the processing module 508 determines if the vehicle is in motion for a time greater than or equal to a second threshold time T₂ as indicated by the telematics data. In an example, the second threshold time T₂ is 2 minutes (120 s), although other values such as 0 s, 30 s, 60 s, 90 s, 180 s or any other length of time could be used. If the vehicle is in motion for a time less than the second threshold time T₂, then processing proceeds to the step s702. If the vehicle is in motion for a time greater than or equal to the second threshold time T₂, then processing proceeds to a step s710. At the step s710, a trip signal is set to active. Processing then proceeds to the step s702. In other words, in examples, if the seat data indicates that the seat is occupied for a time greater than or equal to a first threshold time, and the vehicle is in motion for a time greater than or equal to a second threshold time as indicated by the telematics data, then the trip signal is set to active. For example, when there is a change of the seat sensor data from false to true (i.e. a change from the seat being unoccupied to the seat being occupied such as may occur when a passenger enters the vehicle and sits down) the trip signal may be set to active if the seat is occupied for longer than 60 seconds and the vehicle is in motion for more than two minutes.

In examples, the vehicle is determined to be in motion if a vehicle speed as indicated by the telematics data is greater than a threshold vehicle speed. In examples, the threshold vehicle speed is 16 kph, although other values such as 0 kph, 5 kph, 10 kph, 12 kph, 14 kph, 18 kph, 20 kph or any other speed could be used. For example, the vehicle may be considered to be in motion when then speed of the vehicle is above 16 kph.

In examples, trip start data indicative of a start time of the trip is generated in response to the trip signal being set to active. The trip start data may be based be based on the telematics data. For example, the start time of the trip may be considered to be the time at which the seat sensor detected that a passenger sat on the seat (e.g. a change from the seat being unoccupied (False) to the seat being occupied (True) such as may occur when a passenger enters the vehicle and sits down).

However, in other examples, the trip start time may be the time at which the trip signal was set to active, although this may lead to underreporting of a trip duration. Therefore, in examples, the trip start data may be based on the time stamp of the seat data change from False to True as stored in the memory of the seat data receiving module 504. This may help more accurately reflect the actual start time of a trip.

Returning to the step s704, if the trip is active (i.e. the trip signal indicates the trip is active), then processing proceeds to a step s712.

At the step s712, the processing module 508 determines if the trip is active (trip signal indicates the trip is active) for a time greater than or equal to a third threshold time T₃. In examples, the third threshold time T₃ is 120 s, although other values such as 0 s, 30 s, 60 s, 90 s, 180 s or any other length of time could be used.

If the seat data indicates that the seat is not occupied and the trip signal indicates the trip is active for a time greater than or equal to the third threshold time T₃, then the trip signal is maintained as active. In other words, for example, if the trip is active for greater than or equal to the third threshold time T₃ and the seat signal becomes false (seat unoccupied), then the trip is still considered active. Processing then proceeds to a step s714.

However, if, at the step s712, the trip is not active (trip signal=“Not active”) or the trip signal has been active for less than the third threshold time T₃, then processing proceeds to the step s702. If, at the step s702, the seat is detected not to be occupied, then processing proceeds to the step s712.

Therefore, for example, once the trip signal is set as active, and the trip is longer than the third threshold time T₃, the passenger may move around within the vehicle and the trip still considered active. This may, for example, help improve the accuracy of detecting whether a trip is occurring, as well as helping to provide more flexibility for the passenger if they decide to change seats during the trip.

In some examples, the trip signal may be maintained as active when the vehicle is in motion (i.e. the vehicle's speed is above the threshold vehicle speed) because it is unlikely that a passenger may leave the vehicle while it is in motion. However, if the vehicle is stopped, for example at traffic lights or due to stationary traffic, then it is possible that the trip may not be considered to be active any longer because the vehicle is not moving. Therefore, at the step s714, the processing module 508 determines if the vehicle is not in motion for greater than or equal to a fourth threshold time T₄. In examples, the fourth threshold time T₄ is 30 s, although it will be appreciated that other values such as 0 s, 5 s, 10 s, 20 s, 30 s, 60 s, 90 s, 180 s or any other length of time could be used.

If the vehicle is not in motion for less than the fourth threshold time T₄, then processing proceeds to the step s702. However, if the vehicle is not in motion for greater than or equal to a fourth threshold time T₄, then processing proceeds to a step s716.

At the step s716, the processing module 508 detects if the seat is not occupied for a time greater than or equal to a fifth threshold time T₅, for example based on the seat data. For example, if the vehicle is not in motion for more than the fourth threshold time T₄, and the seat data indicates that the seat is not occupied for greater than or equal to a fifth threshold time T₅, then it is likely that the passenger has left the vehicle and the trip is finished. In examples, the fifth threshold time T₅ is 60 s, although it will be appreciated that other values such as 0 s, 10 s, 20 s, 30 s, 40 s, 50 s, 90 s, 180 s, or any other length of time could be used.

Therefore, in examples, if the trip signal is already set as active, the trip signal is set, at a step s718, to not active if the vehicle is not in motion for greater than or equal to the fourth threshold time T₄, and the seat data indicates that the seat is not occupied for a time greater than or equal to the fifth threshold time T₅.

Accordingly, examples of the disclosure may help automatically detect one or more trips of a vehicle. More generally, in examples, a trip is determined to have occurred if the trip signal is set from active to not active.

In examples, trip end data indicative of an end time of the trip is generated in response to the trip signal being set as not active. For example, when the trip signal is set to “not Active” at the step s718, the trip end data may be generated by the processing module 508. In examples, the processing module 508 may generate the trip output data. The trip output data may comprise trip duration data based on a difference between the trip start time and the trip end time as indicated by the trip start data and the trip end data. In other words, the trip duration data may indicate the duration (length of time) of the trip. In examples, the trip output data may comprise trip distance data. The trip distance data may indicate the distance travelled by the vehicle between the start time and end time of the trip, for example based on the telematics data. In some examples, a machine learning algorithm may be used to determine if a trip has occurred, based on the seat data and a previously trained model.

For example, by automatically detecting whether a trip has occurred, the need for a dispatch or fare system in the vehicle may be reduced.

In examples, the processing module 508 may determine if the time between trips is less than an adjacent trip time threshold. If the time between trips is less than the adjacent trip time threshold, then the processing module 508 may merge adjacent trips together so that they are considered to be the same trip.

In examples, the trip output data comprises a trip data log. In examples, the trip data log comprises one or more of:
Location data—e.g. latitude, longitude up to 4 meters accuracy;
Speed data—in kph and m/s up to 3 decimal places in accuracy;
Direction data—the direction as degrees from 0 to 360 degrees;
Accuracy of location data—the accuracy range from 4 m to 10 m;
Time data—in UTC time up to milliseconds in accuracy;
Fare amount data—in local currency up to 4 decimal places;
Harsh braking data—in meters/s\hat{ }2 or kph/s up to 3 decimal places;
Harsh Acceleration data—in meters/s\hat{ }2 or kph/s up to 3 decimal places;
Harsh Cornering data—in meters/s\hat{ }2 or kph/s up to 3 decimal places;
Overspeeding data—in meters/s\hat{ }2 or kph/s up to 3 decimal places;
Continuous driving time data—in hours up to 3 decimal places;
Engine parameters data—e.g. based on CANBUS (Controller Area Network Bus) data as PIDs (parameters IDs);
Passenger count data—e.g. number of passengers in the vehicle for the duration of the trip as an integer from 0-7 (although could be different depending on the size of the vehicle); and
Driver details data (if available)—e.g. data relating to phone number, name, and driver license details.

In some examples, the trip output data may be sent from the processing module 508 to the RMS 108. In other examples, the RMS 108 and the processing module 508 may cooperate together to generate the trip output data. In examples, the RMS 108 may use the trip output data to generate an estimated fare, for example based on equation 1. This estimated fare generated from the trip output data may be compared with the fare for the trip provided by the TNC to determine if a violation has occurred, for example as described above with reference to FIGS. 1 to 4. In some examples, the trip output data may be aggregated for one or more trips and shared with the transport network company as a trip profile. Additionally it will be appreciated that trip output data may be generated according to the techniques described herein in respect of a plurality of vehicles, such as those operated by a TNC.

For example, a passenger may get into a vehicle (such as a taxi, a car operated by a TNC, limousine, or bus) at an airport and sit on a seat within the taxi. The seat data may be processed according to that described above with respect to FIGS. 5 to 7 to detect the occurrence of a trip. For example, the trip may start at Dubai Airport at 8 am, and end at Sharjah Airport at 10 am. In this example, the taxi may be a premium sports utility vehicle (SUV) and so an additional premium charge may be included in the fare. The RMS 108 may check, based on the trip output data, the pickup location (airport), the type of vehicle (SUV) and the pickup time (8 am) and calculate an appropriate estimated fare based on this data and that the pickup occurred during rush hour (8 am) and the passenger was dropped off at a location outside of a geofenced zone (i.e. within a different municipality than where pickup occurred), thus resulting in a higher rate charge.

For example, the RMS may estimate that the fare for this trip should be 110.50 AED. In this example, the TNC charges 110.45 AED. Therefore, the violation module may determine that a violation has occurred and the TNC may be fined accordingly. For example, the municipality may have an agreement with the TNC that if there is a greater than 0.01 AED difference between the estimated fare generated from the real time vehicle data and the fare of the trip data reported by TNC then a violation is deemed to have occurred. In this example, a violation may be deemed to have occurred if the estimated fare and the reported fare differ from each other by greater than a violation amount. In this example, the violation amount is 0.01 AED although it will be appreciated that other values could be used such as 0.1 AED, 1 AED, 5 AED, 10AED or any other amount. In some examples, the multiplier factor mentioned above with respect to equation 1 may be when determining if a violation has occurred.

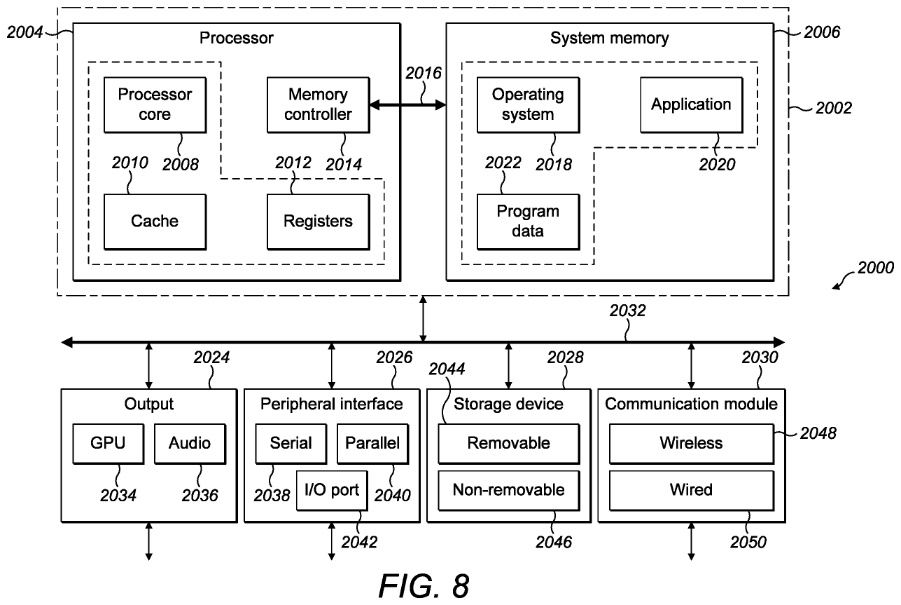

FIG. 8 schematically shows a computer system for implementing methods of examples of the disclosure. In particular, FIG. 8 shows an example of a computing device 2000 for example which may be arranged to implement one or more of the examples of the methods described herein. For example, the computing device may implement the functionality of the RMS 108 and/or violation module 110. The computing device 200 may implement the functionality of the user interface device 112.

In examples, the computing device 2000 comprises main unit 2002. The main unit 2002 may comprise a processor 2004 and a system memory 2006. In examples, the processor 2004 may comprise a processor core 2008, a cache 2010, and one or more registers 2012. In examples, the processor core 2008 may comprise one or more processing cores and may comprise a plurality of cores which may run a plurality of threads. The processor 2004 may be of any suitable type such as microcontroller, microprocessor, digital signal processor or a combination of these, although it will be appreciated that other types of processor may be used.

In examples, the processor core 2008 may comprise one or more processing units. In examples, the processor core 2008 comprises one or more of a floating point unit, an arithmetic unit, a digital signal processing unit, or a combination of these and/or plurality of other processing units, although it will be appreciated that other processing units could be used. In examples, the cache 2010 may comprise a plurality of caches such as a level one cache and a level two cache, although other appropriate cache arrangements could be used.

In examples, the processor 2004 comprises a memory controller 2014 operable to allow communication between the processor 2004 and the system memory 2006 via a memory bus 2016. The memory controller 2014 may be implemented as an integral part of the processor 2004, or it may be implemented as separate component.

In examples, the system memory 2006 may be of any suitable type such as non-volatile memory (e.g. flash memory or read only memory), volatile memory (such as random access memory (RAM)), and/or a combination of volatile and non-volatile memory. In examples, the system memory 2006 may be arranged to store code for execution by the processor 2004 and/or data related to the execution. For example, the system memory may store operating system code 2018, application code 2020, and program data 2022. In examples, the application code 2020 may comprise code to implement one or more of the example methods described herein, for examples to implement the steps described above with reference to FIGS. 3 to 7. The application code 2020 may be arranged to cooperate with the program data 2022 or other media, for example to allow processing of the trip output data, telematics data, real time vehicle data, trip data, and violation data.

In examples, the computing device 2000 may have additional features, functionality or interfaces. For example main unit 2002 may cooperate with one or more peripheral devices for example to implement the methods described herein. In examples, the computing device 2000 comprises, as peripheral devices, an output interface 2024, a peripheral interface 2026, a storage device 208, and a communication module 2030. In examples, the computing device comprises an interface bus 2032 arranged to facilitate communication between the main unit 2002 and the peripheral devices. For example, the storage device may store data of the e-hail database, and or RMS database.

In examples, the output device 2024 may comprise output devices such as a graphical processing unit (GPU) 2034 and audio output unit 2036 for example arranged to be able to communicate with external devices such as a display, and/or loudspeaker, via one or more suitable ports such as audio/video (AN) port. In examples, the peripheral interface 2026 may comprise a serial interface 2038, a parallel interface 2040, and a input/output port(s) 2042 which may be operable to cooperate with the main unit 2002 to allow communication with one or more external input and/or output devices via the I/O port 2042. For example, the I/O port 2042 may communication with one or more input devices such as a keyboard, mouse, touch pad, voice input device, scanner, imaging capturing device, video camera, and the like, and/or with one or more output devices such as a 2D printer (e.g. paper printer), or 3D printer, or other suitable output device.

In examples, the storage device may comprise removable storage media 2044 and/or non-removable storage media 2046. For example, the removable storage media may be random access memory (RAM), electrically erasable programmable read only memory (EEPROM), read only memory (ROM) flash memory, or other memory technology, optical storage media such as compact disc (CD) digital versatile disc (DVD) or other optical storage media, magnetic storage media such as floppy disc, magnetic tape, or other magnetic storage media. However, it will be appreciated that any suitable type of removable storage media could be used. Non-removable storage media 2046 may comprise a magnetic storage media such as a hard disk drive, or solid state hard drive, or other suitable media, although it will be appreciated that any suitable non-removable storage media could be used. The storage device 2028 may allow access by the main unit 2002 for example to implement the methods described herein.

In examples, the communication module may comprise a wireless communication module 2048 and a wired communication module 2050. For example, the wireless communication module may be arranged to communicate wirelessly via a suitable wireless communication standard for example relating to wifi, Bluetooth, near field communication, optical communication (such as infrared), acoustic communication, or via a suitable mobile telecommunications standard. The wired communication module may allow communication via a wired or optical link for example by Ethernet or optical cable. However, it will be appreciated that any suitable communication module could be used. For example, the computing device 2000 may act as a server in communication with the vehicles via a suitable network. The computing device may act as a network connected device, thin client, and/or be configured to implement one or more virtual machines.

In examples, one or more of the telematics module 506 and the processing module 508 may be implemented by the main unit 2002, although it will be appreciated that other suitable implementations could be used. In examples, seat data receiving module 504 may be implemented by the communication module 2030 or the peripheral interface 2026. In some examples the functionality of the ehail database 106, RMS 108, violation module 110, user interface device 112, seat data receiving module 504, telematics module 506, and processing module 508 may be distributed between more than one computing device (such as computing device 2000), for example by communication over a suitable network. In some examples this functionality may be achieved by running one or more virtual machines implemented in a cloud computing environment. Additionally, it will be appreciated that one or more of the elements, modules described herein could be implemented using dedicated hardware running appropriate code.

It will be appreciated that while the processing module 508 has been described as implementing at least some elements of the steps mentioned with respect to FIGS. 6, and 7, the steps of the methods may be implemented on other suitable apparatus such as a distributed computing environment, or dedicated hardware and software, for example.

It will be appreciated that in examples of the disclosure, elements of the disclosed methods may be implemented in a computing device (such as the computing device described above with reference to FIG. 8) in any suitable manner. For example, a conventional computing device may be adapted to perform one or more of the methods described herein by programming/adapting one or more processors of the computing device. As such, in examples, the programming/adapting may be implemented in the form of a computer program product comprising computer implementable instructions stored on a data carrier and/or carried by a signal bearing medium, such as floppy disk, hard disk, optical disk, solid state drive, flash memory, programmable read only memory (PROM), random access memory (RAM), or any combination of these or other storage media or signal bearing medium, or transmitted via a network such as a wireless network, Ethernet, the internet, or any other combination of these or other networks.

In other words, in examples, a computer program may comprise computer readable instructions which, when implemented on a computer (or processor), cause the computer to carry out a method according examples of the disclosure. In examples, a storage medium may comprise the computer program, for example, as mentioned above. For example, a computer program may comprise software which, when implemented on the processing module 508 causes the apparatus 500 to carry out one or more of the methods described herein. In some examples, the RMS 108, e-hail database 106 and violation module 110 may all be implemented on the same computing device, although they could be implemented on different computing devices.

It will also be appreciated that other suitable computer architectures could be used such as those based on one or more parallel processors. Furthermore, at least some processing may be implemented on one or more graphical processing units (GPUs) as appropriate.

The techniques of the disclosure may be applied to any type of vehicle or vehicles. For example, the vehicle may be a taxi, limousine, car, bus, sports utility vehicle (SUV), off road vehicle (4×4), scooter, bicycle, motorcycle, unmanned aerial vehicle (UAV) or other aerial vehicle such as a passenger drone (e.g. a so-called flying taxi) for carrying passengers, helicopter or other aircraft, or any other appropriate type of vehicle. Furthermore, it will be appreciated that the techniques described herein may apply to many different types of vehicle that are associated with a TNC or with more than one TNC and that they need not all be the same vehicle type where more than one vehicle is considered.

Other examples and features of the disclosure are set out in the following numbered clauses.

1. A method for detecting trips of a vehicle, the method comprising:

generating, using a seat sensor associated with a seat located in the vehicle, seat data indicative of whether a vehicle occupant is occupying the seat;

receiving seat data from the seat sensor;

receiving telematics data indicative of one or more attributes of motion of the vehicle;

determining if a trip has occurred based on the seat data and the telematics data; and

generating trip output data indicative of attributes of the trip if a trip is determined to have occurred.

2. A method according to clause 1, comprising setting a trip signal to active if the seat data indicates that the seat is occupied for a time greater than or equal to a first threshold time, and the vehicle is in motion for a time greater than or equal to a second threshold time as indicated by the telematics data.
3. A method according to clause 2, comprising generating trip start data indicative of a start time of the trip in response to the trip signal being set to active, the trip start data being based on the telematics data.
4. A method according to clause 2 or clause 3, comprising maintaining the trip signal as active if the seat data indicates the seat is not occupied and the trip signal indicates the trip is active for a time greater than or equal to a third threshold time.
5. A method according to any of clauses 2 to 4, in which, if the trip signal is set as active, the method comprises setting the trip signal to not active if the vehicle is not in motion for greater than or equal to a fourth threshold time, and the seat data indicates that the seat is not occupied for a time greater than or equal to a fifth threshold time.
6. A method according to clause 5, comprising generating trip end data indicative of an end time of the trip in response to the trip signal being set as not active.
7. A method according to clause 6, in which the trip output data comprises trip duration data based on a difference between the trip start time and the trip end time as indicated by the trip start data and the trip end data.
8. A method according to any of clauses 2 to 7, in which a trip is determined to have occurred if the trip signal is set from active to not active.
9. A method according to any of clauses 2 to 8, in which the vehicle is determined to be in motion if a vehicle speed as indicated by the telematics data is greater than a threshold vehicle speed.
10. A method according to any preceding clause, in which the seat sensor comprises a pressure sensitive sensor located beneath the seat for generating the seat data.
11. A method according to clause 10, comprising generating seat data indicating that the vehicle occupant is occupying the seat if a detected weight as indicated by the seat sensor is greater than a threshold weight.
12. Apparatus for detecting trips of a vehicle, the apparatus comprising:

a seat sensor associated with a seat located in the vehicle, the seat sensor being operable to generate seat data indicative of whether a vehicle occupant is occupying the seat;

a seat data receiving module operable to receive the seat data from the seat sensor;

a telematics module operable to receive telematics data indicative of one or more attributes of motion of the vehicle;

a processing module operable to:
determine if a trip has occurred based on the seat data and the telematics data; and
generate trip output data indicative of attributes of the trip if a trip is determined to have occurred.
   13. A computer program comprising software, which when implemented on the processing module of the apparatus of clause 12, causes the apparatus to carry out a method according to any of clauses 1 to 11.
   14. A storage medium comprising a computer program according to clause 13.
   15. A vehicle comprising the apparatus according to clause 12.

Although a variety of examples have been described herein, these are provided by way of example only and many variations and modifications on such examples will be apparent to the skilled person and fall within the spirit and scope of the present invention, which is defined by the appended claims and their equivalents.

1. A fine generation method for automatic generation of fines related to a transport network associated with a transportation network company, the method comprising:
receiving, by a regulatory monitoring system, real time vehicle data related to a vehicle within the transport network;
receiving, from a transportation network company, trip data relating to one or more trips of the vehicle;
storing the trip data in a database;
generating violation data by analysing the real time vehicle data and the trip data stored in the database to detect if a violation has occurred; and
generating a fine based on the violation data.

2. A method according to claim 1, comprising generating estimated fare data from the real time vehicle data.

3. A method according to claim 1 or claim 2, in which the trip data comprises reported fare data for a trip that is reported by the transportation network company.

4. A method according to claim 3, in which:
generating the violation data comprises comparing a reported fare as indicated by the reported fare data with an estimated fare as indicated by the estimated fare data; and
generating the fine comprises generating the fine if a predetermined condition with respect to the reported fare and the estimated fare is satisfied.

5. A method according to claim 4, in which the predetermined condition is that the estimated fare is a threshold amount different from the reported fare.

6. A method according to any previous claim, in which the vehicle data comprises telematics data indicative of one or more attributes of position of the vehicle.

7. A method according to claim 6, in which the telematics data comprises one or more of: vehicle location; vehicle speed; vehicle direction; and vehicle acceleration.

8. A method according to claim 6 or claim 7, in which the vehicle data comprises seat data generated using a seat sensor associated with a seat located in the vehicle, the seat data being indicative of whether a vehicle occupant is occupying the seat.

9. A method according to any preceding claim, in which the vehicle data comprises one or more of: toll gate data; vehicle type data; engine parameter data; passenger count data; and driver identification data.

10. A fine generation system for automatic generation of fines related to a transport network associated with a transportation network company, the fine generation system comprising:
a regulatory monitoring system operable to receive real time vehicle data related to a vehicle within the transport network;
a database operable to receive, from the transportation network company, trip data relating to trips of the vehicle, and to store the trip data; and
a violation module operable to generate violation data by analysing the real time vehicle data and the trip data stored in the database to detect if a violation has occurred, and to generate a fine based on the violation data.

11. A computer program comprising software, which when implemented on a processor, causes the processor to carry out a method according to any of claims 1 to 9.

12. A storage medium comprising a computer program according to claim 11.
